(19) United States
(12) Patent Application Publication
(10) Pub. No.: US 2012/0188334 A1
(43) Pub. Date: Jul. 26, 2012

(54) Generating 3D stereoscopic content from monoscopic video content

(75) Inventors: Philippe Fortin, Montreal (CA); Jean-Louis Bertrand, Montreal (CA)

(73) Assignee: BERFORT MANAGEMENT INC., Laval (CA)

(21) Appl. No.: 13/239,613

(22) Filed: Sep. 22, 2011

Related U.S. Application Data
(60) Provisional application No. 61/385,319, filed on Sep. 22, 2010.

(51) Int. Cl. H04N 13/00

(52) U.S. Cl. 348/43; 348/E13.064

(57) ABSTRACT

An automated method for producing 3D stereoscopic image pairs (left and right) from a single image source, such as a 2D video frame. The resulting 3D stereoscopic video content is then displayable as 3D content, e.g., on a compatible 3D display, or available for further processing. According to the method, and for each frame in a sequence, first and second luminosity maps are generated. The first luminosity map is applied to the frame to generate a first image of a stereoscopic pair, and the second luminosity map is applied to the frame to generate the second (corresponding) image of the stereoscopic pair. Each pixel in each frame is processed independently to generate the respective luminosity maps.

### CROSS-REFERENCE TO RELATED APPLICATION

This application is based on and claims priority from Ser. No. 61/385,319, filed Sep. 22, 2010.

### COPYRIGHT STATEMENT

This application includes subject matter protected by copyright. All rights are reserved.

### BACKGROUND

1. Technical Field

This disclosure relates generally to stereoscopic 3D content conversion and display technologies, methods and apparatus.

2. Background of the Related Art

Stereopsis is the process in visual perception leading to the sensation of depth from two slightly different projections of the world onto the retina of each eye. The differences in the two retinal images are referred to as binocular disparity.

It is desirable to be able to convert two-dimensional (“2D”) monoscopic (“2D”) content, such as video content, to three-dimensional (“3D”) stereoscopic content and, in particular, by creating a pair of left/right images for each original (source) 2D video frame. Such images can then be used for various display purposes, e.g., in auto-multiscopic displays. Auto-multiscopy is a method of displaying three-dimensional (3D) images that can be viewed without the use of special headgear or glasses by the viewer. This display method produces depth perception in the viewer, even though the image is produced by a flat device. Several technologies exist for auto-multiscopic 3D displays, such as a flat-panel solution that use lenticular lenses. If the viewer positions his or her head in certain viewing positions, he or she will perceive a different image with each eye, thus providing a stereo image.

### BRIEF SUMMARY

This disclosure provides an automated method for producing 3D stereoscopic image pairs (left and right) from a single image source, such as a 2D video frame. The resulting 3D stereoscopic video content is then displayable as 3D content, e.g., on a compatible 3D display (such as a 3D TV), or stored (e.g., on permanent storage) for further processing (e.g., a video editing process).

The disclosure technique preferably is computationally-efficient and thus optimized to allow its use as part of a real-time 2D-to-3D video conversion solution. In one embodiment, the 3D stereoscopic image(s) are generated from a single source image by creating a pair of “luminosity maps” (or, more generally, data sets or structures) to assist into the separation of various elements of the 2D image. As used herein, a “luminosity map” identifies a set of absolute difference values that are generated by processing a source image frame. Each absolute difference value represents an absolute difference measured between a given pixel and the pixel at a distance of luminosity patch offset pixels to the left and to the right of the given pixel. Preferably, the luminosity maps are used in a volumetric stereopsis creation routine (a machine-implemented process) to generate disparity information between the illuminated elements in a more natural way than what is possible using other known approaches (e.g., a depth map approach). The disparity information that is generated in this manner is then used to generate left and right images that can be combined (e.g., using known 3D stereo encoding techniques, such as side-by-side, top-bottom, frame sequential or other formats) to form the stereo pair.

The automatic conversion technique more efficiently generates a realistic separation of the elements of the 2D image to improve the relative depth perception and to preserve the resolution of High Definition (HD) video content (e.g., 1080p or higher) than what is currently available from the prior art. This automatic conversion technique can be used as part of an off-line 3D conversion process to reduce and sometimes eliminate the need to apply additional transformations to the original 2D image to create a more elaborate 3D image.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 illustrates a high level view of an overall image capture, processing and display technique according to an embodiment of this disclosure;

FIG. 2 illustrates a representative sample 2D video frame image from which the stereoscopic image pairs are generated according to this disclosure;

FIG. 3 illustrates the concept of specular reflection that is exploited by the disclosed technique;

FIG. 4 illustrates a luminosity map according to this disclosure;

FIG. 5A illustrates a first luminosity map generated from the 2D video frame image of FIG. 2;

FIG. 5B illustrates a second luminosity map generated from the 2D video frame image of FIG. 2;

FIG. 6A illustrates a left image that results from executing the volumetric stereopsis creation routine of this disclosure against the first and second luminosity maps;

FIG. 6B illustrates a right image that results from executing the routine against the first and second luminosity maps;

FIG. 7 illustrates representative code for implementing the volumetric stereopsis creation routine;

FIG. 8 illustrates a representative stereoscopic 3D content conversion apparatus that implements the above-described techniques and that, optionally, may be used within or in conjunction with a video display system;

FIG. 9 illustrates an alternative embodiment of the video display system of FIG. 8;

FIG. 10 illustrates a representative digital signal processor (DSP)/FPGA for use in the 3D conversion apparatus of FIG. 8; and

FIG. 11 illustrates a representative motherboard configuration for the 3D conversion apparatus.

### DETAILED DESCRIPTION OF AN EMBODIMENT

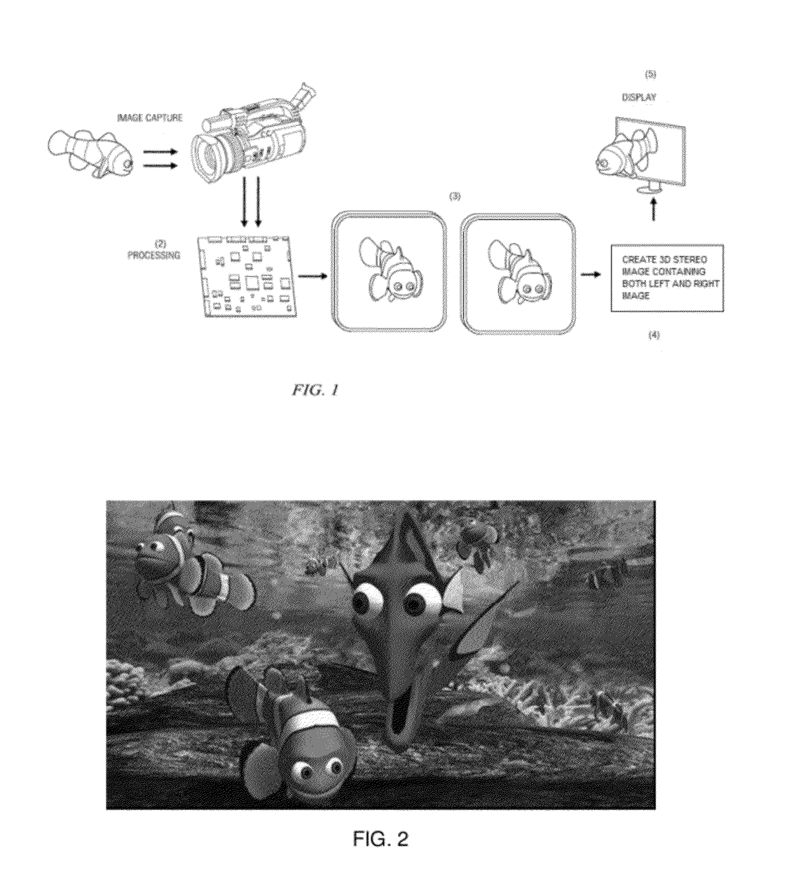

FIG. 1 illustrates a high level view of an overall image capture, processing and display technique according to this disclosure. Using a video source (step 1), an operator captures the original content. A single lens camera 100 may be used for this purpose, although this is not a limitation, as any video source (including video frames received from an external source) may be used. A High-Definition (HD) 3D processor board 102 associated with the camera converts the original image into HD 3D content by processing (step 2) and generating two individual images, namely, left and right images 102 and 104 (step 3). Images 102 and 104 are merged together (step 4) into a single HD image. The resulting HD 3D content is then stored, e.g., on an integrated SSD device, in an external storage area network (SAN), in cloud-based storage, or the like. The HD 3D content can also be displayed (step 5), e.g., in real-time on a stereoscopic display device, to allow visualization of the captured content. Other processing, storage and retrieval functions may be implemented.

As noted, image capture using a camera (such as illustrated in FIG. 1) is not required. In an alternative, the video content is made available to (received at) the system in a suitable format (e.g., as HD content). Whether the content is captured live or provided on-demand (e.g., from a data store), preferably the following technique is used to generate a stereoscopic pair from the 2D video frame image. The technique as described preferably is implemented for each 2D video frame image comprising the 2D video content of interest. Preferably, the disclosed technique is implemented in a field-programmable gate array (FPGA), although this is not a limitation. The system components may be implemented in any processing unit (e.g., a CPU, a GPU, or combination thereof) suitably programmed with computer software.

By way of additional background, the volumetric stereopsis creation process of this disclosure preferably leverages the notion of specular reflection, wherein an angle of reflection (θᵣ) of a light source is equal (and coplanar) to an angle of incidence (θᵢ) of the light source. This property is illustrated in FIG. 2. As will be described in more detail below, this property in effect is used to recreate (or to simulate) the way the left eye and right eye of a human being perceive a given object from slightly different angles to trigger stereopsis in the human brain.

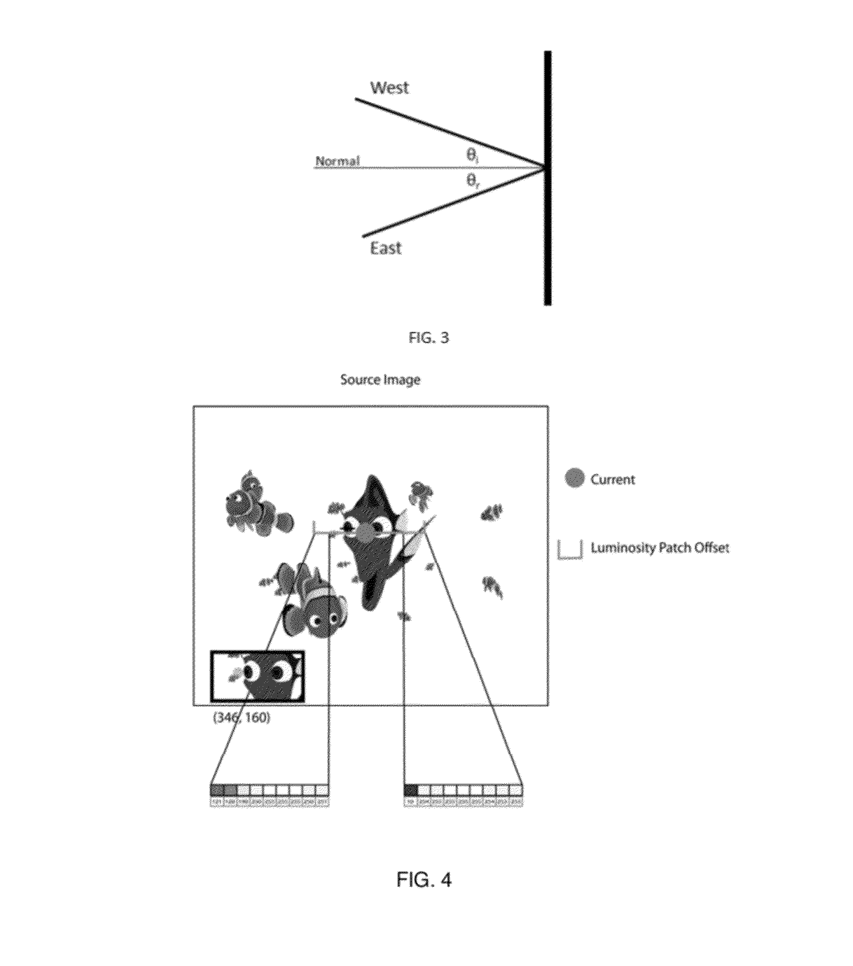

Referring now to FIG. 3, which illustrates a technique for generating a luminosity map, the width of the luminosity patch offset is used to determine the width (in pixels) of the edge that should be added to each display object (in the video frame) to enhance the volume of the object, as part of the stereopsis process, resulting in a more natural 3D appearance. Without such processing as provided herein, the objects in the frame may look flat, very much like a stack of images. According to this disclosure, a “width” of a luminosity patch offset is determined based on a desired amount of separation of each object from other nearby objects as well as the image background. For computational efficiency, the luminosity patch offset value in defined in terms of a number (integer or fraction) of pixels.

Preferably, the luminosity patch offset value also is based on an actual width of the object, which may be determined via a typical edge detection technique such as a Canny edge detector, a differential edge detector, or the like. Although in one embodiment, the edge detection method is applied on a per-line basis, this is not a limitation, as it is also possible to apply the edge detection technique on multiple lines. The wider an object is within a video frame, the wider the luminosity patch offset value should be to generate a luminosity map that more closely mimics the natural stereopsis of the human brain. To handle every desired object in an image frame, preferably the luminosity patch offset is adjusted dynamically while processing each pixel (and its components), in particular, by incorporating an additional edge detection step prior to the generation of the luminosity map. This prior step is used (optionally) to define the luminosity patch offset as a fraction of the width of each detected object. By default, the luminosity patch offset is adjusted by a fixed percentage (usually configured between a minimum and a maximum percentage) of the detected width, but in one implementation, this fixed percentage may be controlled by an operator via a user interface, or programmatically.

As can be seen in FIG. 3, the luminosity patch offset in effect is used to “light-up” one side (e.g., a WEST side, or so-called negative offset) of the object and the opposed side (e.g., an EAST side, or positive offset) of the object to create a luminosity map. As noted above, a luminosity map is available in-memory as an internal representation. Based on the example source image (FIG. 2), FIG. 4A represents an EAST luminosity map, while FIG. 4B represents a WEST luminosity map. For some content, optionally the luminosity map may be determined by processing each pixel on a vertical axis (column by column), rather than on a “per line” basis. This alternative is left to the operator's discretion (or it may be implemented programmatically) depending on the natural orientation of the content or by other preference.

Preferably, the volumetric stereopsis creation process is executed separately for each component (RGB) of a pixel to avoid unwanted artifacts. This means that the luminosity patch offset as described preferably is applied to each component of a given pixel. For performance reasons, especially when the volumetric stereopsis creation process is used as part of a real-time 3D conversion solution, it is desirable to apply the process uniformly to each sub-component of the pixel in a single pass. The luminosity map for each pixel preferably is determined by subtracting from it the value of a pixel component to the left of a current pixel component for the WEST side, and by subtracting the value of the pixel component to the right of the current pixel component for the EAST side. This approach helps to enhance the details of certain elements of an image without the need to manually manipulate each pixel.

The volumetric stereopsis creation routine works as follows. For each frame in a movie or sequence of images that are desired to be processed, preferably each line of each frame is processed in sequence. The luminosity map is calculated for each pixel to determine the edge of each object and to enhance the edges by increasing the specular reflection as needed (based on the width of the luminosity patch offset) until each pixel of each desired image in the movie or sequence is processed. Using the original source image (FIG. 2) and the pair of internally-generated luminosity maps (FIG. 4A and FIG. 4B), the process generates the left/right pair of images (for each video frame) that may be displayed on a suitable device (such as a 3D TV), and/or stored (e.g., on transitory or permanent storage) for further processing. To replicate the natural view from the left eye, preferably the value of the luminosity for a given pixel is a difference between the WEST and the EAST side (as if the light source originated from the left side). Preferably, the luminosity for the right eye is a difference between the EAST and the WEST side to simulate a light source that originates from the right side.

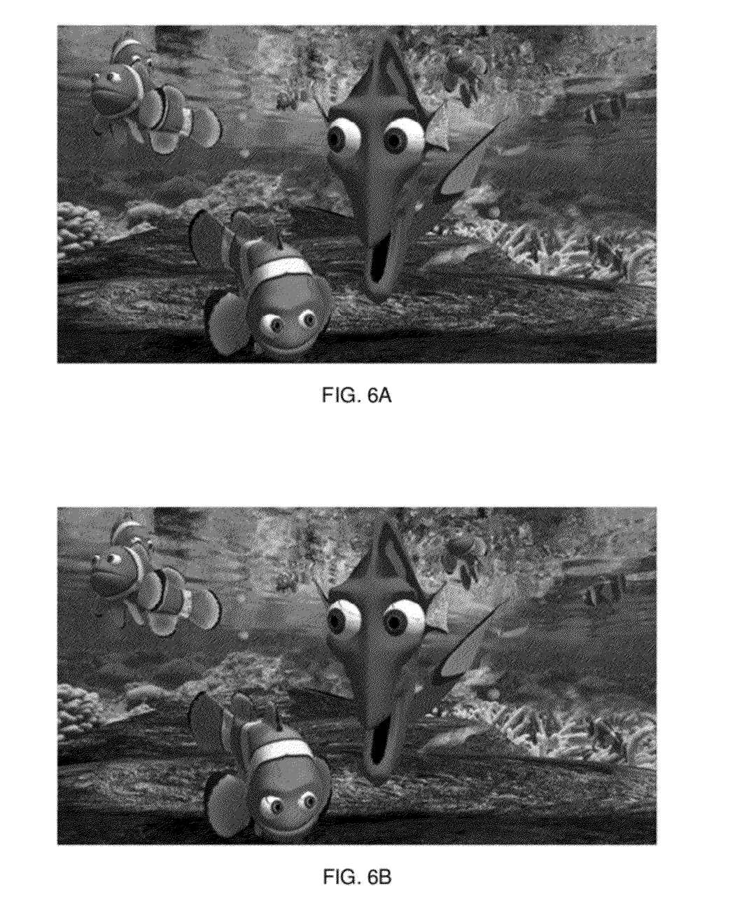

As a result of executing the volumetric stereopsis creation routine, the left image (such as shown in FIG. 6A) is obtained from the original source image (FIG. 2) by adding a difference between the WEST and the EAST luminosity map (for each pixel) to the original value of the pixel in the source image. Preferably, the resulting color is adjusted by a configurable color-threshold value to eliminate potential over-bright pixels that could result from the calculated values in the appropriate luminosity map. Likewise, the right image (such as shown in FIG. 6b) is obtained from the original source image by adding a difference between the EAST and the WEST luminosity map to the original value of the pixel in the source image. Again, preferably the resulting color is adjusted by a configurable color-threshold value to eliminate potential over-bright pixels.

If desired, the 2D to 3D volumetric stereopsis creation process is parameterized to adjust the 3D effects for each video frame (or image). One embodiment uses the following parameters:
Luminosity patch offset: as noted above, this value controls the width (in number of pixels) that is used to adjust the angle of incidence for the specular reflection. The number of pixels can be specified as fraction of a pixel.
X-step: this parameter is calculated based on the total number of pixels for a line (1/number of lines) based on the resolution of the source video. For instance, when the resolution is set to 1080p, the X-step is defined as 1/1920^{th} of a line.
Y-step: this parameter is calculated based on the total number of pixels for a column (1/number of columns) based on the resolution of the source video. For instance, when the resolution is set to 1080p, the Y-step is defined as 1/1080^{th} of a column.
Color-threshold: this parameter is a color threshold factor used to eliminate potential over-bright pixels that may occur when combining the original pixel with the corresponding pixel from the luminosity maps. This is a percentage value between 1% and 100%
Fx-power: this parameter optionally is used to increase the width of the objects by increasing the X-step value during the creation of the luminosity maps.

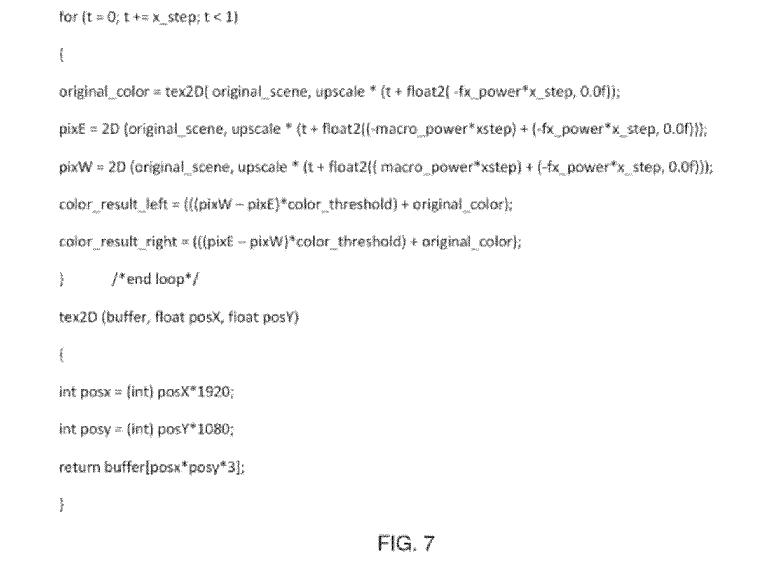

The code listing in FIG. 7 provides an implementation of the volumetric stereopsis creation process (the code can either be used with integer or floating point values). The code is implemented in a computer program or process that is executed by a processor (or processors). A processor executes on a machine, such as a computer. A processor may comprise one or more sub-processes or sub-routines executing on or more machines that may be co-located or remote from one another.

Generally, and has been described, the process determines a difference between a leftmost pixel and a rightmost pixel of a luminosity patch offset determined by a configurable luminosity patch offset parameter. When the difference is zero, the luminosity patch is still within the boundaries of an object and there are no edges to enhance. A small difference may represent a fluctuation of shade (or color) inside an object, while a larger difference indicates an edge of the object being illuminated (which edge should therefore be further illuminated). By enhancing the edges (and therefore the perceived volume of the object with specular reflection) in this manner, the image mimics the way the left eye and the right eye perceive a given object from slightly different angles, thereby helping to trigger stereopsis in the human brain. If desired, this stereopsis can be further enhanced by disparity techniques that are beyond the scope of this disclosure.

The processing loop defined in FIG. 7 modifies the value of each sub-component of each pixel by a predefined color-threshold parameter. When the difference is small, it will increase the nuance inside the object (or portion) of the image, further increasing the inner edges of an object resulting is an enhanced stereoscopic viewing experience. When the difference is more significant, it will help to create a more perceivable edge around the object, which results in a better separation from the surrounding object and the background of the image. As noted, this processing further increases the stereoscopic view and helps trigger stereopsis in the viewer's brain.

Preferably, the processing loop in FIG. 7 is repeated for each component (such as RGB) of each pixel.

In other words, preferably the luminosity process described above operates on a per-pixel basis and does not use nor require any knowledge about the calculated luminosity values of other pixels.

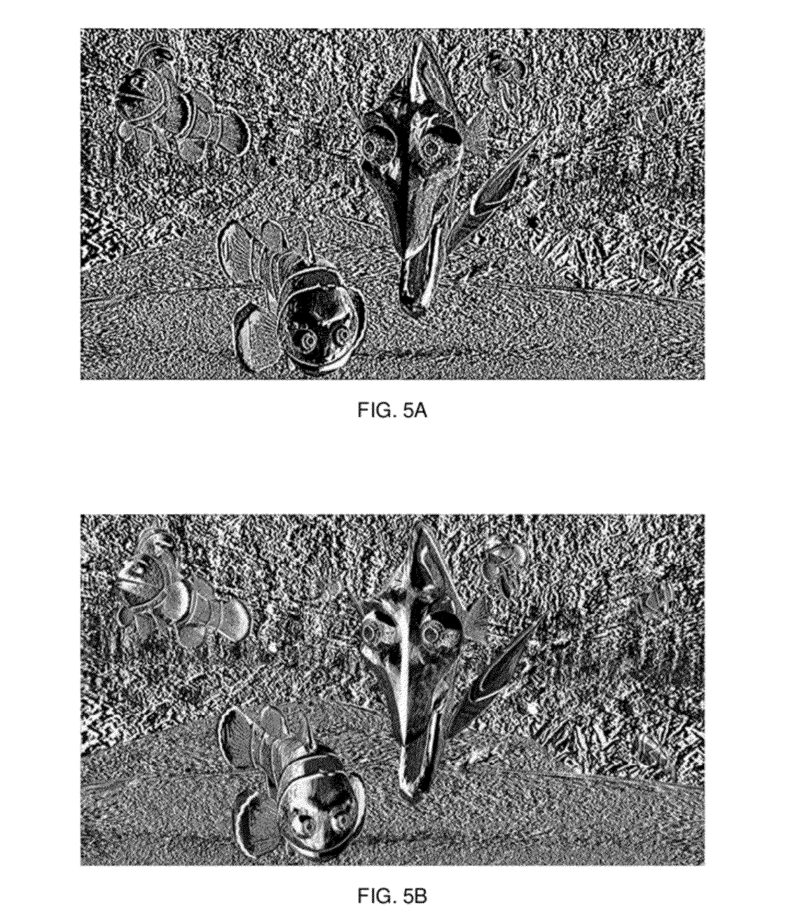

Thus, according to this disclosure, for each pixel (of each frame of a 2D source image), a left value is generated, as well as a right value. The left values for all pixels in the frame are collected and comprise the left luminosity map (FIG. 5A, for example), and the right values for all pixels in the frame are collected and comprise the right luminosity map (FIG. 5B, for example). There are thus left and right luminosity maps for each frame of the 2D source image. The set of luminosity maps are then used to generate the left and right stereoscopic pairs that are used for display. In particular, taking the source image frame, the left luminosity map is added thereto (pixel-by-pixel) to generate the left version of the stereoscopic pair; likewise, the right luminosity map is added to the current source image frame (pixel-by-pixel) to generate the right version of the stereoscopic pair. Thus, in this process, and for each pixel of the source image frame, the value of the corresponding pixel in the luminosity map (left or right, as the case may be) is added to the value of the pixel (in the source image frame) to generate the value of the pixel in the left or right version of the stereoscopic pair. This process is repeated for each pixel in the source image frame to generate the corresponding version of the stereoscopic pair.

In a preferred embodiment, and for each pixel in a current frame of the source image, the value of the corresponding pixel in the left image of a stereoscopic pair is obtained by calculating the difference between the left luminosity value and the right luminosity value. The resulting difference is then multiplied by a color threshold to eliminate any potential brightness problem and then added to the value of the pixel in the current frame to generate the corresponding pixel in the left image of a stereoscopic pair. The value of the corresponding pixel in the right image of a stereoscopic pair is obtained by calculating the difference between the right luminosity value and the left luminosity value. The resulting difference is multiplied by a color threshold to eliminate any potential brightness problem and then added to the value of the pixel in the current frame to generate the corresponding pixel in the right image of the stereoscopic pair.

The above-described technique can be optimized to operate within a single processing loop so that storage of the luminosity maps is obviated.

### Apparatus

The disclosed technique may be used in a number of applications. One such application is a 3D conversion device (3D box or device) that can accept multiple 3D formats over a standard video interface. The 3D conversion box implements the above-described technique. For instance, version 1.4 of the HDMI specification defines the following formats: Full resolution Side-by-Side, Half resolution Side-by-Side, Frame alternative (used for Shutter glasses solutions), Field alternative, Left+depth, and Left+depth+Graphics+Graphics depth.

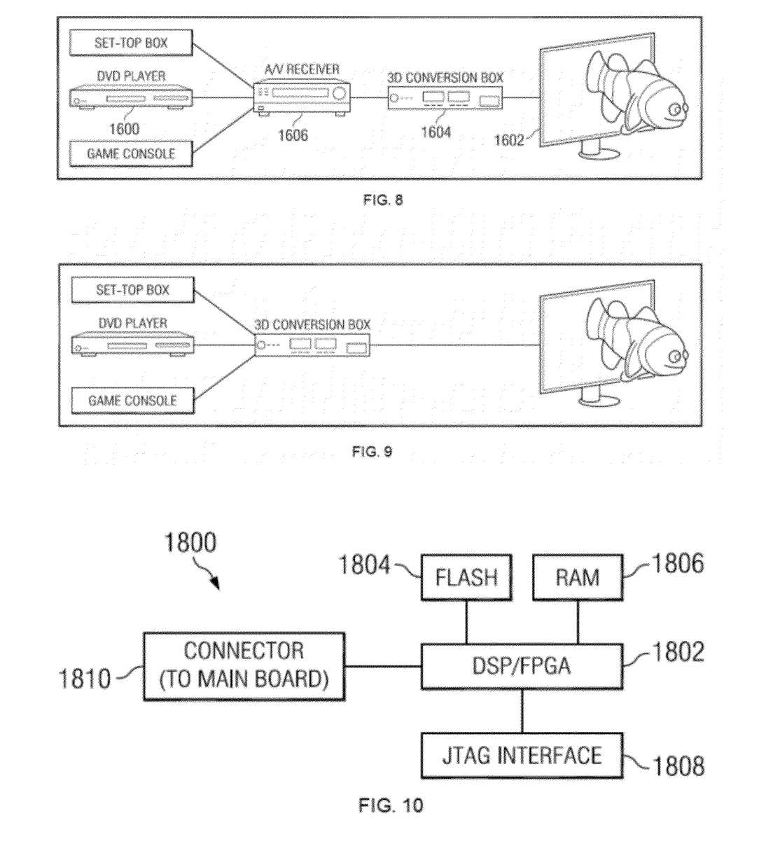

A 3D box may be implemented in two (2) complementary versions, as shown in FIG. 8 and FIG. 9. In one embodiment, the box (or, more generally, device or apparatus) 1604 is installed between an Audio/Video Receiver 1606 and an HD display 1602. As such, the 3D box comes with a pair of HDMI interfaces (Input and Output) that are fully compliant with the recently introduced version 1.4 of the HDMI specification and version 2.0 of the High-bandwidth Digital Content Protection (HDCP) specification. This is illustrated by the conceptual diagram in FIG. 8. As can be seen in FIG. 16, any HD video source 1600 can be shown on an auto-multiscopic display 1602 irrespective of the format of the HD video source. By feeding multiple views (e.g., preferably at least 9, and up to 126) to the auto-multiscopic display, viewers can feel the 3D experience anywhere in front of the display rather than being limited to a very narrow “sweet spot” as was the case with earlier attempts at delivering glasses-free solutions. In an alternative embodiment, such as shown in FIG. 9, one or more various HD Video sources (Set-Top Box, Blu-ray player, Gaming console, etc.) are connected directly to one of the HDMI ports built into the 3D box which in turn connects directly to the HD display. To handle multiple video formats (2D or 3D), preferably the 3D Box also acts as an HDMI hub facilitating its installation without having to make significant changes to the original setup. If desired, the 3D Box 1604 can provide the same results by leveraging the popular DVI (Digital Video Interface) standard instead of the HDMI standard.

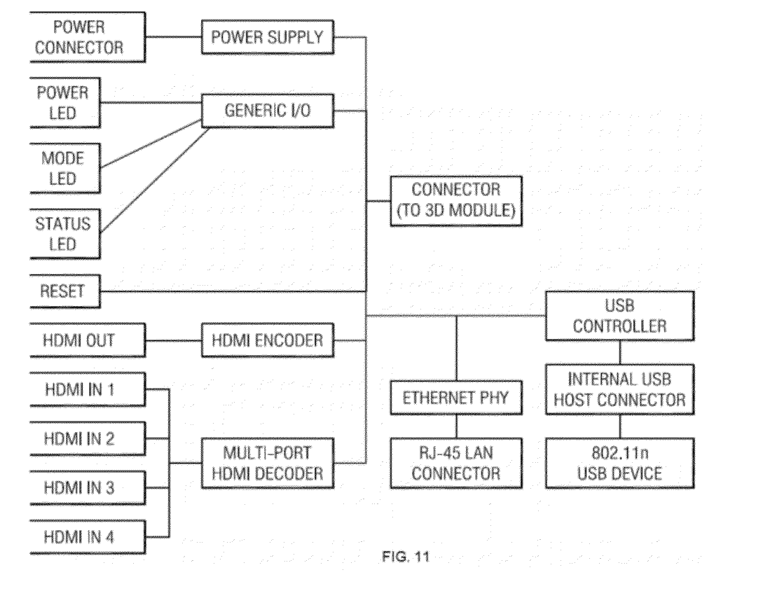

A representative design of a hardware platform required to deliver the above 3D Box is based on the use of a digital signal processor/field-programmable gate array (DSP/FPGA) platform with the required processing capabilities. To allow for the embedding of this capability in a variety of devices including, but not limited to, an auto-multiscopic display, the DSP/FPGA may be assembled as a module 1800 as shown in FIG. 10. The DSP/FPGA 1802 is the core of the 3D module. It executes the 3D algorithms (including, without limitation, the partial disparity and view generator/interweaver) and interfaces to the other elements of the module. Flash memory 1804 hosts a pair of firmware images as well as the necessary configuration data. RAM 1806 stores the 3D algorithms. A JTAG connector 1808 is an interface to facilitate manufacturing and diagnostics. A standard-based connector 1810 connects to the motherboard, which is shown in FIG. 11. Motherboard comprises standard video interfaces and other ancillary functions, which are well-known. An HDMI decoder handles the incoming HD Video content on the selected HDMI port. An HDMI encoder encodes the HD 3D frame to be sent to the display (or other sink device).

The above-described hardware and/or software systems in which the technique for producing 3D stereoscopic image pairs (left and right) from a single image source are implemented are merely representative. The described functionality may be practiced, typically in software, on one or more computing machines. Generalizing, a computing machine typically comprises commodity hardware and software, storage (e.g., disks, disk arrays, and the like) and memory (RAM, ROM, and the like). An apparatus for carrying out the computation (or portions thereof) comprises a processor, and computer memory holding computer program instructions executed by the processor for carrying out the one or more described operations. The particular machines used in a system of this type are not a limitation. One or more of the above-described functions or operations may be carried out by processing entities that are co-located or remote from one another. A given machine includes network interfaces and software to connect the machine to a network in the usual manner. A machine may be connected or connectable to one or more networks or devices, including display devices. More generally, the above-described functionality is provided using a set of one or more computing-related entities (systems, machines, processes, programs, libraries, functions, or the like) that together facilitate or provide the inventive functionality described above. A representative machine is a network-based data processing system running commodity hardware, an operating system, an application runtime environment, and a set of applications or processes that provide the functionality of a given system or subsystem. As described, the product or service may be implemented in a standalone server, or across a distributed set of machines.

The functionality may be integrated into a camera or other image capture or processing device/apparatus/machine, an audiovisual player/system, an audio/visual receiver, or any other such system, sub-system or component. As illustrated and described, the functionality (or portions thereof) may be implemented in a standalone device or component.

While the above describes a particular order of operations performed by certain embodiments, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While given components of the system have been described separately, one of ordinary skill will appreciate that some of the functions may be combined or shared in given instructions, program sequences, code portions, and the like.

Having described our invention, what we now claim is set forth below.

1. Apparatus, comprising:
a processor;
computer memory holding program instructions executed by the processor to generate 3D stereoscopic information from monoscopic video content by the following method, the monoscopic video content comprising a sequence of frames:
for each frame in the sequence:
generating first and second luminosity maps; and
applying the first luminosity map to the frame to generate a first image of a stereoscopic pair; and
applying the second luminosity map to the frame to generate a second image of the stereoscopic pair.

2. The apparatus as described in claim 1 wherein the first and second luminosity maps are generated as follows:
for each frame, processing each line in sequence from a first line to a last line;
for a given pixel in each line, calculating respective first and second luminosity values, the first luminosity values comprising a set of absolute differences as measured between the given pixel and the pixel at an offset value to a left of the given pixel in the line, the second luminosity values comprising a set of absolute differences as measured between the given pixel and the pixel at an offset value to a right of the given pixel in the line.

3. The apparatus as described in claim 2 wherein the offset is a luminosity patch offset.

4. The apparatus as described in claim 2 wherein a first luminosity value for each pixel is determined by subtracting from it the value of a pixel component to the left of a current pixel component, and a second luminosity map for each pixel is determined by subtracting the value of the pixel component to the right of the current pixel component.

5. The apparatus as described in claim 2 wherein the luminosity value for each pixel is internally stored in the first luminosity map for the values measured on the left side of the pixels, and wherein the luminosity value for each pixel is stored in a second luminosity map for the values measured on the right side of the pixels.

6. The apparatus as described in claim 2 wherein a first luminosity value is calculated as the absolute difference between the given pixel and the pixel at an offset value above the given pixel and wherein the second luminosity value is calculated as the absolute difference between the given pixel and the pixel at an offset value below the given pixel.
